(19) United States
(12) Patent Application Publication
(10) Pub. No.: US 2015/0245276 A1
(43) Pub. Date: Aug. 27, 2015

(54) TOPOLOGY MANAGEMENT METHOD AND NETWORK SYSTEM PERFORMING THE SAME

(71) Applicant: Samsung Electronics Co., Ltd., Gyeonggi-do (KR)

(72) Inventors: Sung Hee LEE, Gyeonggi-do (KR); Ashish Gupta, Gyeonggi-do (KR); Chang Soon Kim, Gyeonggi-do (KR); Su Hyun Yoon, Gyeonggi-do (KR)

(21) Appl. No.: 14/628,974

(22) Filed: Feb. 23, 2015

(30) Foreign Application Priority Data
Feb. 23, 2014 (KR) 10-2014-0021011

(51) Int. Cl. H04W 40/24

(52) U.S. Cl. CPC H04W 40/246; H04W 84/18

(57) ABSTRACT

A topology management method of a node, a non-transitory computer readable recording medium, and an electronic device are provided. The method includes transmitting, by the node, a unicast message comprising its presence information to at least one neighbor node in a network; receiving, by the node, an acknowledgement message for the unicast message; and receiving, by the node, first broadcast messages each of which comprises presence information on each of the at least one neighbor node.

### PRIORITY

This application claims priority under 35 U.S.C. §119(a) to a Korean Patent Application filed Feb. 23, 2014 in the Korean Intellectual Property Office and assigned Serial No. 10-2014-0021011, the entire contents of which are incorporated herein by reference.

### BACKGROUND

1. Field of the Invention

The present invention relates generally to a topology management method and a network system, and more particularly, to a topology management method and a network system that can rapidly and accurately identify a network status by using broadcast and unicast messages.

2. Description of the Related Art

In an ad-hoc network system autonomously configuring a network via wireless communication among nodes, a network status is frequently changed by fading due to movement of nodes and obstacles, interference with signals using similar frequency bands, or environmental factors. The ad-hoc network system continuously identifies a change in the network status and sets or changes a route by reflecting such change in topology information.

FIG. 1 illustrates a mobile ad-hoc network system.

Referring to FIG. 1, an ad-hoc network system includes at least one node. In the ad-hoc network system, a network is autonomously configured via wireless communication among nodes without a base station or an access point. Hereinafter, a mobile ad-hoc network system is described.

Five nodes (i.e., a node 1, a node 2, a node 3, a node 4, and a node 5) shown in FIG. 1 represent a mobile ad-hoc network system according to an embodiment of the present invention. In the mobile ad-hoc network system, each node transmits a broadcast message including its presence information to neighbor nodes in the network. Each node may configure a network topology on the basis of broadcast messages received from the neighbor nodes. The network topology represents routes through which data is delivered in the network or connection status of nodes.

Since a distance at which a node is able to communicate with another node(s) is limited, the node in the mobile ad-hoc network system communicates with a remote node by using multi-hop routing. Hereinafter, for convenience of explanation, a distance at which a node is able to communicate with another node(s) is described as a coverage area.

For example, when node 1 attempts to communicate with node 5, node 1 transmits data to node 5 via a route connecting node 1, node 2, node 3, node 4, and node 5. The route connecting node 1, node 2, node 3, node 4, and node 5 may be set on the basis of broadcast messages received from the neighbor nodes.

Due to free movement of nodes in a mobile ad-hoc network system, the network status is frequently changed. For example, the network status may be changed in the case where node 2 moves outside of a coverage area of node 1, a new neighbor node moves inside of the coverage area of node 1, or link quality deteriorates due to movement of a node.

In order to properly cope with a change in network status due to movement of a node, each node periodically transmits a broadcast message including its presence information. Each node may continuously identify a change in the network status on the basis of broadcast messages received from neighbor nodes and update the network topology. In such a way, via continuous identification of a change in the network status, each node may search for neighbor nodes in its vicinity, measure link quality, and manage the network topology.

In a mobile ad-hoc network system, the network topology may be dynamically changed according to the network status, and communication among nodes may be performed via a route set on the basis of topology information.

For mobile wireless nodes, message loss may occur due to Radio Frequency (RF) interference. In particular, when a node uses the Industrial, Scientific, and Medical (ISM) band with a Wireless Local Area Network (WLAN) and Bluetooth, RF interference may intensify.

For example, as shown in FIG. 1, a broadcast message 20 transmitted from node 3 may be lost in a wireless interval. When node 2 does not receive the broadcast message 20 transmitted from node 3 due to RF interference etc., node 2 determines that node 3 is out of the coverage area of node 2 and a link 10 between node 2 and node 3 may be disconnected. Accordingly, data transmitted from node 1 may be lost.

### SUMMARY

The present invention has been made to address the above-mentioned problems and disadvantages, and to provide at least the advantages described below. Accordingly, an aspect the present invention provides a topology management system and a network system.

Another aspect of the present invention provides a non-transitory computer readable recording medium having a program executable in a computer recorded thereon.

In accordance with an aspect of the present invention, a topology management method of a node is provided. The method includes transmitting, by the node, a unicast message including its presence information to at least one neighbor node in a network; receiving, by the node, an acknowledgement message for the unicast message; and receiving, by the node, first broadcast messages each of which includes presence information on each of the at least one neighbor node.

In accordance with another aspect of the present invention, a non-transitory computer readable recording medium having a program recorded thereon, which, when executed by a computer, performs a topology management method is provided. The method includes transmitting, by a node, a unicast message comprising its presence information to at least one neighbor node in a network; receiving, by the node, an acknowledgement message for the unicast message; and receiving, by the node, first broadcast messages each of which includes presence information on each of the at least one neighbor node.

In accordance with another aspect of the present invention, an electronic device of a network is provided. The electronic device includes a transmission module configured to transmit a second broadcast message or a unicast message including its presence information to neighbor electronic devices; a reception module configured to receive a unicast acknowledgment message for the unicast message and first broadcast messages and a unicast message from the neighbor electronic devices; and a status identifying module configured to identify a status of the network on a basis of the unicast acknowledgment message and the first broadcast messages and the unicast message received from the neighbor electronic devices.

### BRIEF DESCRIPTION OF THE DRAWINGS

The above and other aspects, features, and advantages of the present invention will be more apparent from the following detailed description, taken in conjunction with the accompanying drawings, in which:

FIG. 1 illustrates a conventional mobile ad-hoc network system;

FIG. 2 illustrates an ad-hoc network system according to an embodiment of the present invention;

FIG. 3 is a graph for explaining a packet loss rate in an ad-hoc network system according to an embodiment of the present invention;

FIG. 4 is a flowchart of a topology management method performed in each node of an ad-hoc network system according to an embodiment of the present invention;

FIG. 5 is a flowchart of a topology management method performed in each node of an ad-hoc network system according to an embodiment of the present invention;

FIG. 6 is a flowchart of a topology management method performed in each node of an ad-hoc network system according to an embodiment of the present invention;

FIG. 7 is a block diagram of an electronic device according to an embodiment of the present invention;

FIG. 8 is a block diagram of a system including an electronic device according to an embodiment of the present invention;

FIG. 9 is a block diagram of an electronic device according to an embodiment of the present invention; and

FIG. 10 is a flowchart of a topology management method performed in each node of an ad-hoc network system according to an embodiment of the present invention.

### DETAILED DESCRIPTION OF EMBODIMENTS OF THE PRESENT INVENTION

Hereinafter, the present invention will be described in detail by explaining embodiments of the present invention with reference to the attached drawings. The present invention may be variously modified and realized in various forms, and thus embodiments will be exemplified in the drawings and described in detail herein below. However, the present invention is not limited to the disclosed forms, and must be construed to include all modifications, equivalents, or replacements included in the scope and spirit of the present invention. In the description of the drawings, like reference numerals are used to denote like constituent elements.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The expression “or” used herein includes any and all combinations of enumerated words. For example, “A or B” may include A, B, or both A and B.

It will be understood that, although the terms first, second, etc. may be used herein to describe various elements, these elements should not be limited by these terms. These terms are only used to distinguish one element from another. For example, a first user device and a second user device are but different user devices. For example, a first element could be termed a second element, and, similarly, a second element could be termed a first element, without departing from the scope and spirit of an embodiment.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

The terminology used herein is for the purpose of describing embodiments of the present invention only and is not intended to be limiting of the present invention. It is to be understood that the singular forms “a,” “an,” and “the” include plural referents unless the context dearly indicates otherwise.

Unless otherwise defined, all terms used herein have the same meaning as commonly understood by one of ordinary skill in the art to which the present invention pertains, and should not be interpreted as having an excessively comprehensive meaning nor as having an excessively contracted meaning. If a technical term used herein is erroneous and fails to accurately express the technical idea of the present invention, it should be replaced with a technical term that allows a person skilled in the art to properly understand. The general terms used herein should be interpreted according to the definitions in a dictionary or in the context and should not be interpreted as an excessively contracted meaning.

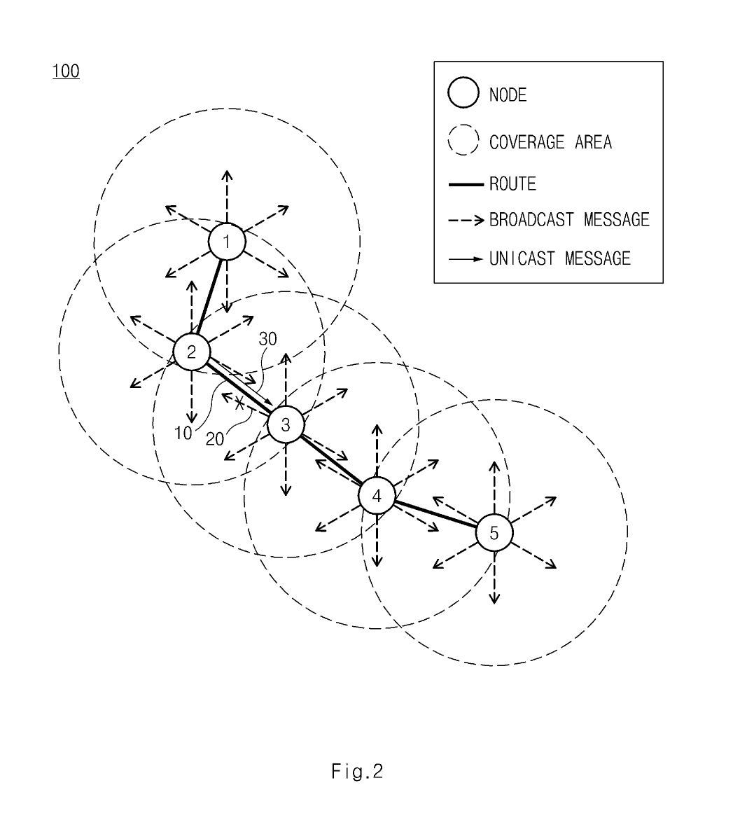

FIG. 2 illustrates an ad-hoc network system 100 according to an embodiment of the present invention.

The ad-hoc network system 100 according to an embodiment of the present invention includes a mobile ad-hoc network system. The ad-hoc network system 100 according to an embodiment of the present invention includes at least one node transmitting, to neighbor nodes, a broadcast message and a unicast message and identifying a network status on the basis of a unicast acknowledgement message for the unicast message, and broadcast messages and unicast messages received from the neighbor nodes.

A node according to an embodiment of the present invention includes an electronic device such as a smart phone, notebook computer, digital broadcast terminal, digital camera, portable game terminal, Personal Digital Assistant (PDA), Portable Multimedia Player (PMP), a navigation device, or tablet Personal Computer (PC). A node may also include various wearable electronic devices such as a smart watch, smart glass, electronic bracelet, electronic ankle bracelet, electronic necklace, electronic ring, or electronic belt, etc. A node is not limited hereto and may include information and communication devices, multimedia devices, and all application devices for them.

In an embodiment of the present invention, the ad-hoc network system 100 is described as including five nodes (i.e., node 1, node 2, node 3, node 4, and node 5).

Each node transmits a broadcast message including its presence information to neighbor nodes in the ad-hoc network system 100, and a unicast message including its presence information to at least one neighbor node. Each of the broadcast and unicast messages respectively includes a broadcast packet and a unicast packet.

Each node identifies the network status on the basis of the broadcast and unicast messages received from neighbor nodes, and a unicast acknowledgement message from a neighbor node that received the unicast message.

Compared to the broadcast message transmitted to all destinations that can receive the broadcast message (i.e., broadcast message transmitted to neighbor nodes within a coverage area of the broadcasting node), the unicast message is transmitted to at least one predetermined destination (i.e., a neighbor node). The neighbor node receiving the unicast message transmits a unicast acknowledgement message for the unicast message to the node that transmitted the unicast message. After transmitting the unicast message, the node retransmits the unicast message when a unicast acknowledgement message is not received within a predetermined time from the neighbor node to which the unicast message has been transmitted. The predetermined time represents an expected time for a node to receive a unicast acknowledgement message from a neighbor node after the node transmits the unicast message to the neighbor node. Accordingly, the node is capable of transmitting its presence information using the unicast message.

The larger the number of nodes in an ad-hoc network, the larger the amount of traffic. Accordingly, in the case of transmitting a unicast message, a node may adjust at least one of the number of transmission times of a broadcast message and the number of transmission times of the unicast message.

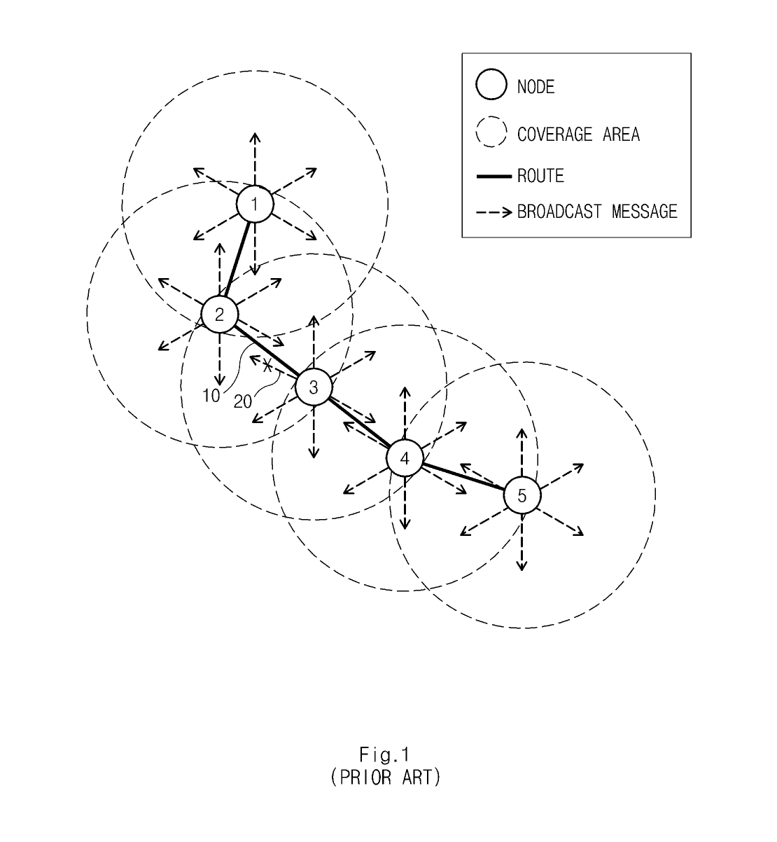

Referring to FIG. 2, each node communicates with a remote node by using multi-hop routing as in FIG. 1. For example, node 1 transmits data to node 5 via a route connecting node 1, node 2, node 3, node 4, and node 5.

The route connecting node 1, node 2, node 3, node 4, and node 5 may be set on the basis of a broadcast message, a unicast message, and a unicast acknowledgement message received from neighbor nodes.

Each node continuously identifies a change in a network status on the basis of a broadcast message, a unicast message, and a unicast acknowledgement message received from neighbor nodes, and search nodes which are able to communicate therewith from among the neighbor nodes. Each node measures link qualities with neighbor nodes which are able to communicate therewith and manages the network topology. Each node measures the link qualities using a packet reception rate. The ad-hoc network system 100 selects an optimal route on the basis of the link qualities.

A node updates topology information according to a network status. The topology information includes presence information of a node such as whether a new neighbor node enters a coverage area of the node. Each node sets a route or changes a route on the basis of the topology information.

According to a ratio of the number of times a broadcast message is transmitted to the number of times a unicast message is transmitted, a node periodically transmits a broadcast message and a unicast message. The ratio is determined theoretically or experimentally. In an embodiment of the present invention, although the ratio is described as the number of times a broadcast message is transmitted to the number of times a unicast message is transmitted, the present invention is not limited thereto. In an embodiment of the present invention, a broadcast message is transmitted periodically and a unicast message is transmitted therebetween. In addition, a unicast message may be transmitted according to the network status.

A node respectively transmits a broadcast message and a unicast message each a number of times according to a ratio. For example, a node may repeatedly transmit three broadcast messages then one unicast message in a time interval or sequence (i.e., a broadcast message to unicast message ratio of 3:1).

A node determines the ratio of the number of broadcast message transmissions to the number of unicast message transmissions on the basis of the network status.

Table 1 represents performance improvement rate for a case where a network status is identified with a broadcast message and a unicast message. For example, in Table 1, the performance improvement rate is measured in an actual environment by transmitting a broadcast message and unicast message in a 3:1 ratio. A test was conducted with a total of 6 nodes disposed in a linear topology having a maximum of 400 m distance. As shown in Table 1, in a case where a broadcast message and a unicast message are transmitted in a 3:1 ratio, the average number of times a route changed per minute declined by 40%, and an average route maintaining time increased by 66%. This indicates that the route is relatively stable. In addition, since an average packet loss rate declined by 25%, it may be seen that actual data transmission performance increased. The ratio of the numbers of transmission times of the broadcast message to the unicast message is not limited to 3:1, and the transmission of the broadcast message and unicast message may be conducted in various ratios according to various embodiments.

TABLE 1
Performance comparison of network status identification
according to unicast message transmission

| | | | Broadcast to | | |
|---|---|---|---|---|---|
| | Broadcast | | unicast message | | Performance |
| | message | | transmission | | improvement |
| | transmission | | (3:1 ratio) | | rate |
| Average number | 11 | times | 6.6 | times | 40% |
| of route changes | | | | | |
| per minute | | | | | |
| Average route | 5.4 | seconds | 9 | seconds | 66% |
| maintaining time | | | | | |

| | | | |
|---|---|---|---|
| Average packet | 12.6% | 9.4% | 25% |
| loss rate | | | |

According to an embodiment of the present invention, a node may adaptively adjust the ratio of the number of broadcast message transmissions to the number of unicast message transmissions according to at least one of link quality, a movement speed of the node, and the number of neighbor nodes changing according to the network status. As the ratio of the number of broadcast message transmissions to the number of unicast message transmissions increases, traffic amount decreases, but reliability also decreases. In contrast, as the ratio of the number of unicast message transmissions to the number of broadcast message transmissions increases, reliability increases, but traffic amount also increases. Accordingly, by adaptively adjusting the ratio of the number of broadcast message transmissions to the number of unicast message transmissions according to a situation, link quality is accurately determined and traffic burden is minimized.

When transmitting the broadcast and unicast messages, as the link quality between nodes decreases, each node increases the ratio of the number of unicast message transmissions to the number of broadcast message transmissions. For example, when the link quality is less than a designated value for link quality, a node relatively increases the ratio of the number of unicast message transmissions to the number of broadcast message transmissions. When the link quality is greater than the designated value for link quality, the node relatively increases the ratio of the number of broadcast message transmissions to the number of unicast message transmissions.

Alternatively, each node may increase the ratio of the number of unicast message transmissions to the number of broadcast message transmissions, as a movement speed thereof increases. Since the link quality is likely to decrease as the moving speed of the node increases, the node increases the ratio of the number of unicast message transmissions to the number of broadcast message transmissions. For example, the node relatively increases the ratio of the number of unicast message transmissions to the number of broadcast message transmissions when the movement speed thereof is greater than a designated value for movement speed, and relatively increases the ratio of the number of broadcast message transmissions to the number of unicast message transmissions when the movement speed is less than the designated value for movement speed.

Alternatively, each node lowers the ratio of the number of unicast message transmissions to the number of broadcast message transmissions as the number of neighbor nodes increases. As the number of neighbor nodes increases, traffic amount is likely to increase. Accordingly, the node increases the ratio of the number of broadcast message transmissions to the number of unicast message transmissions. For example, when the number of neighbor nodes is greater than a designated value for the number of neighbor nodes, the node relatively increases the ratio of the number of broadcast message transmissions to the number of unicast message transmissions. When the number of neighbor nodes is less than the designated value for neighbor nodes, the node relatively increases the ratio of the number of unicast message transmissions to the number of broadcast message transmissions. In this case, the node identifies the network status by adjusting the ratio of the number of unicast message transmissions to the number of broadcast message transmissions according to at least one of link quality for each neighbor node, moving speed of the node, and the number of neighbor nodes.

According to an embodiment of the present invention, a node periodically transmits a broadcast message in a period, and transmits a unicast message on-demand only when an event causing a change in a network status occurs. The period represents a period in which a broadcast message is transmitted for identifying the network status. As the period shortens, the node may more rapidly and accurately identify the network status, but the amount of traffic increases. The period may be a value determined theoretically or experimentally.

An event may be at least one of receiving a broadcast message from a new neighbor node and not receiving a broadcast message within a predetermined time from a neighbor node from which a broadcast message has been received. However, the present invention is not limited thereto, and the event may include all cases causing a change in the network status. The predetermined time represents an expected time for a node to receive a unicast acknowledgement from a neighbor node that received a unicast message. For example, the predetermined time may be defined according to performance or protocol characteristics of the node.

When a broadcast message is received from a new neighbor node, the node transmits a unicast message and rapidly and accurately determined whether the new neighbor node is within a coverage area of the node.

Table 2 represents a new node search time in a case where the broadcast and unicast messages are transmitted. For example, Table 2 compares new node search times between a case of transmitting a broadcast message and a case of transmitting a broadcast message and an event-based unicast message. As shown in Table 2, it may be seen that an average new node search time is 0.4 second (i.e., 80% quicker) when transmitting a broadcast message and an event-based unicast message as compared to transmitting just a broadcast message.

TABLE 2
Comparison of average new node search times

| | | Transmission of |
|---|---|---|
| | Transmission of | broadcast and unicast |
| | broadcast message | messages |
| Average new node | 2.2 seconds | 0.4 second |
| search time | | |

In addition, when a broadcast message is not received for a predetermined time from a neighbor node from which a broadcast message has been received, a node transmits a unicast message and identifies whether the neighbor node that has been in a coverage area is out of the coverage area or is in a temporary disconnection status. The temporary disconnection may be a case where the corresponding neighbor node is located within the coverage area of the node but from which a broadcast message is not received due to packet loss or RF interference.

The node identifies whether the corresponding neighbor node is in the temporary disconnection status within the coverage area of the node or is out of the coverage area of the node on the basis of a unicast acknowledgement message transmitted from the neighbor node that received a unicast message. When the corresponding neighbor node is confirmed to be out of the coverage area of the node, the node updates the topology information. When the neighbor node is in a temporary disconnection status within the coverage area of the node, the node does not update topology information.

Referring to FIG. 2, similarly to in FIG. 1, the broadcast message 20 transmitted from node 3 to node 2 may be lost in a wireless period. Even when node 2 does not receive the broadcast message 20 transmitted from node 3, node 2 may rapidly and accurately determine the network status via a unicast message 30.

Node 2 determines whether node 3 is out of the coverage area of node 2 or is in a temporary disconnection status by transmitting the unicast message 30. When the broadcast message 20 transmitted from node 3 is lost during transmission, a link 10 between node 2 and node 3 is maintained. Alternatively, when node 3 is confirmed as being out of the coverage area of node 2 via a unicast acknowledgement message, the link 10 between node 2 and node 3 is disconnected.

In this case, the ad-hoc network system according to an embodiment of the present invention is able to rapidly and accurately identify the network status via the broadcast and unicast messages. Accordingly, data loss can be reduced. In addition, the node can rapidly identify whether a neighbor node is out of a coverage area of the node or is in a temporary disconnection status within the coverage area.

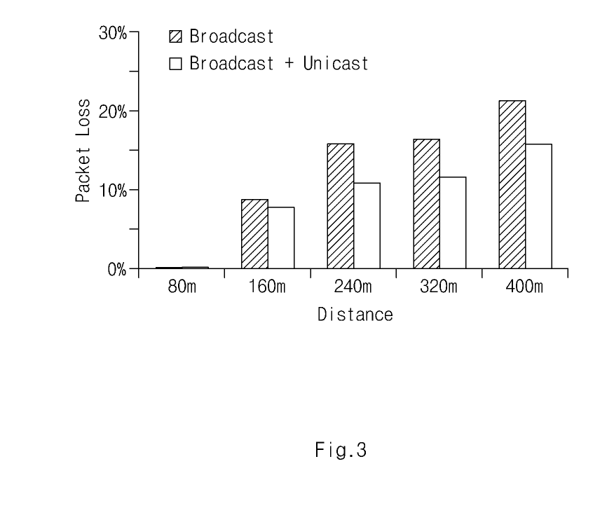

FIG. 3 is a graph representing packet loss rate in an ad-hoc network system according to an embodiment of the present invention.

For example, FIG. 3 compares average packet loss rate between a case of transmitting just a broadcast message and a case of transmitting a broadcast message and a unicast message. FIG. 3 shows average packet loss rate at different distances between nodes. As the distance between nodes increases, the packet loss rate increases. It may be seen that, as the distance between nodes increases, a difference in the packet loss rate between the case of transmitting just the broadcast message and the case of transmitting the broadcast and unicast messages increases. Referring to FIG. 3, when the distance between nodes is 240 m or farther, the packet loss rate is reduced by at least 25%. However, results may vary according to characteristics of nodes or protocols.

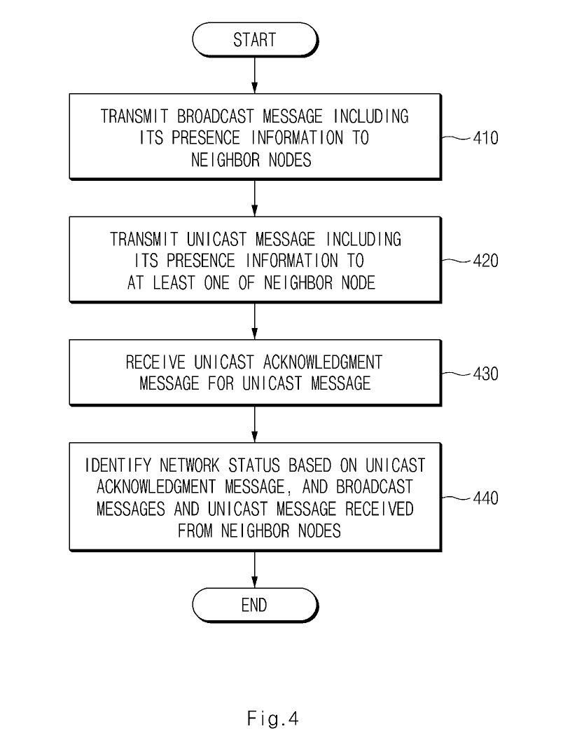

FIG. 4 is a flowchart of a topology management method performed by each node in an ad-hoc network system according to an embodiment of the present invention.

Referring to FIG. 4, the flowchart shown in FIG. 4 includes steps processed by at least one node shown in FIG. 2. Although omitted hereinafter, content described above in relation to at least one node in FIG. 2 may also be applied to the flowchart in FIG. 4.

In step 410, a node transmits a broadcast message including its presence information to neighbor nodes in an ad-hoc network.

In step 420, the node transmits a unicast message including its presence information to at least one neighbor node in the mobile ad-hoc network.

According to an embodiment of the present invention, the node periodically transmits a broadcast message and a unicast message according to a predetermined ratio of the number of unicast message transmissions to the number of broadcast message transmissions. Accordingly, the node respectively transmits the broadcast and unicast messages a number of times according to the predetermined ratio. According to the predetermined ratio, the node performs only one of step 410 or step 420. For example, the node transmits only the broadcast message to the neighbor nodes and does not transmit the unicast message on the basis of the predetermined ratio. In addition, the node transmits only the unicast message to the neighbor node and does not transmit the broadcast message on the basis of the predetermined ratio.

For example, on the basis of the network status, the node determines a ratio of the number of unicast message transmissions to the number of broadcast message transmissions, and transmits the broadcast and unicast messages according to the determined ratio.

Alternatively, according to link quality between the node and a neighbor node which is able to communicate with the node among the neighbor nodes, the ratio of the number of unicast message transmissions to the number of broadcast message transmissions may be adaptively adjusted for each node. As the link quality decreases, the node increases the ratio of the number of unicast message transmissions to the number of broadcast message transmissions.

In step 430, the node receives a unicast acknowledgement message for the unicast message from a neighbor node to which the unicast message has been transmitted. After transmitting the unicast message, the node retransmits the unicast message when the unicast acknowledgement message is not received within a predetermined time from the neighbor node to which the unicast message has been transmitted. The predetermined time represents an expected time for a node to receive a unicast acknowledgement message from a neighbor node that received the unicast message.

In step 440, the node identifies the network status on the basis of the unicast acknowledgement message and broadcast messages and unicast message received from the neighbor nodes. The identification of the network status includes determination of at least one of a neighbor node which is able to communicate with the node among the neighbor nodes and link quality with the neighbor node which is able to communicate with the node.

Step 430 may be performed when step 410 is performed. Step 440 may be performed when step 420 is performed. Only one of step 430 or step 440 may be performed. For example, when step 410 is performed but step 420 is not performed, only step 430 may be performed. In addition, when only step 420 is performed and step 410 is not performed, only step 440 may be performed and step 430 may not be performed.

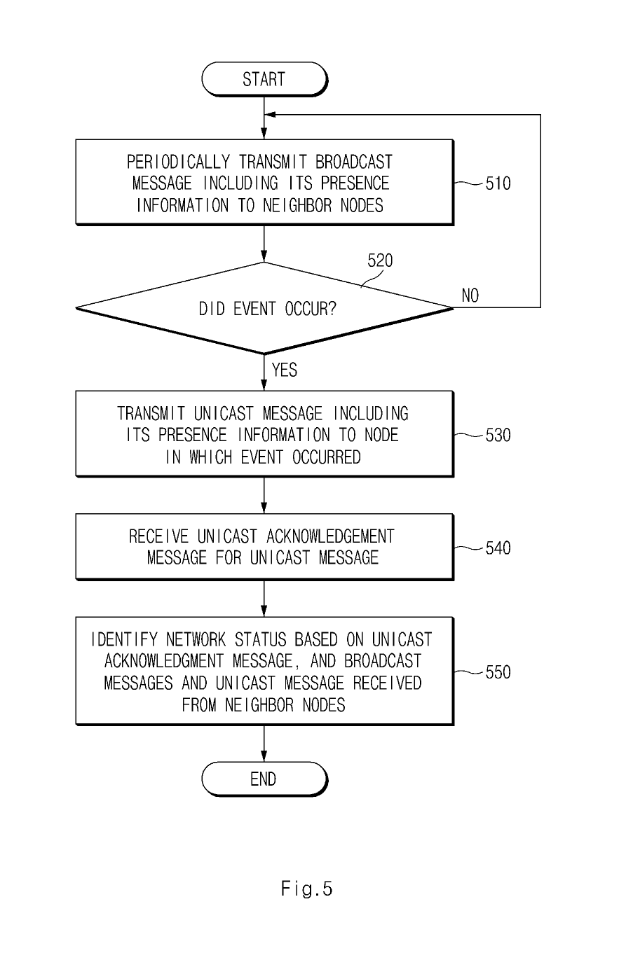

FIG. 5 is a flowchart of a topology management method performed in each node of an ad-hoc network system according to an embodiment of the present invention.

Referring to FIG. 5, the flowchart illustrated in FIG. 5 includes steps processed in time series in at least one node illustrated in FIG. 2. Although omitted hereinafter, content described above in relation to at least one node in FIG. 2 may also be applied to the flowchart in FIG. 5.

In step 510, a node transmits a broadcast message including its presence information to neighbor nodes in an ad-hoc network. The node transmits the broadcast message in a predetermined period. The predetermined period is a period in which the broadcast message is transmitted for identifying a network status, and is determined theoretically or experimentally.

In step 520, the node determines whether an event causing a change in the network status occurs. The event includes at least one of receiving a broadcast message from a new neighbor node and not receiving a broadcast message for a predetermined period from a neighbor node from which a broadcast message has been received. However, the present invention is not limited thereto, and the event may include all cases causing a change in the network status. When the event occurs, the method proceeds to step 530. When the event does not occur, the method proceeds to step 520.

In step 530, the node transmits a unicast message including its presence information to a neighbor node in which the event occurs. After transmitting a unicast message, the node retransmits the unicast message when a unicast acknowledgement message is not received within a predetermined time from a neighbor node that received the unicast message. The predetermined time represents an expected time for the node to receive a unicast acknowledgement message from a neighbor node that received a unicast message.

In step 540, the node receives the unicast acknowledgement message for the unicast message from the neighbor node to which the unicast message has been transmitted.

In step 550, the node identifies the network status on the basis of the unicast acknowledgement message and broadcast messages and unicast message received from neighbor nodes. As described above, the node rapidly and accurately identifies the network status by transmitting broadcast messages in a predetermined period and transmitting a unicast message only when an event causing a change in the network status occurs.

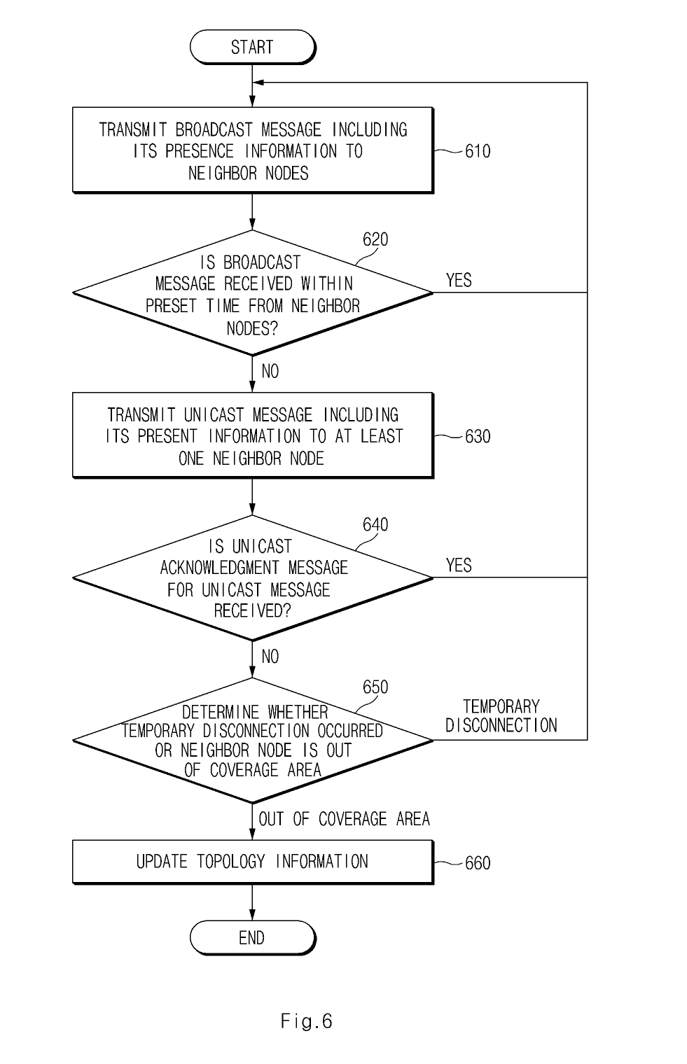

FIG. 6 is a flowchart of a topology management method performed in each node of the ad-hoc network system according to an embodiment of the present invention.

Referring to FIG. 6, the flowchart illustrated in FIG. 6 includes steps processed in time series in at least one node illustrated in FIG. 2. Although omitted hereinafter, content described above in relation to at least one node in FIG. 2 may also be applied to the flowchart in FIG. 6.

In step 610, a node transmits a broadcast message including its presence information to neighbor nodes in an ad-hoc network.

In step 620, the node determines whether broadcast messages are received from the neighbor nodes within a predetermined time. The predetermined time represents time according to a period in which the broadcast message is transmitted for identifying the network status.

When the broadcast messages are received within the predetermined time from neighbor nodes from which broadcast messages have previously been received, step 610 is performed. When the broadcast messages are not received within the predetermined time, the method proceeds to step 630.

In step 630, the node transmits a unicast message including its presence information to at least one neighbor node. For example, when the broadcast message is not received within the predetermined time from a neighbor node from which a broadcast message has previously been received, the node transmits a unicast message to the corresponding neighbor node.

In step 640, the node determines whether a unicast acknowledgement message for the unicast message is received from the neighbor node to which the unicast message has been transmitted.

When the unicast acknowledgement message is received from the neighbor node to which the unicast message has been transmitted, the method proceeds to step 610. The node determines packet loss of the broadcast message.

When the unicast acknowledgement message is not received, the method proceeds to step 650.

In step 650, the node identifies whether not receiving an acknowledgement message for the unicast message is due to a temporary disconnection within a coverage area of the node or the neighbor node is out of the coverage area on the basis of whether the unicast acknowledgement message is received. In the case of temporary disconnection within the coverage area, the method proceeds to step 610. In the case where the neighbor node is out of the communication region, the method proceeds to step 660.

In step 660, the node updates topology information. For example, if the neighbor node is identified as being out of the coverage area, the node updates its topology information. The topology information includes the network topology and presence information on the node such as whether the neighbor node is out of the coverage area of the node or a new neighbor node enters the coverage area of the node. Each node sets a route or changes a set route on the basis of the topology information.

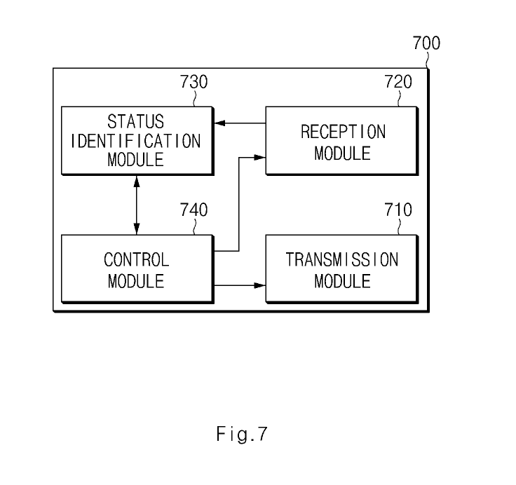

FIG. 7 is a block diagram of an electronic device 700 according to an embodiment of the present invention.

Referring to FIG. 7, the electronic device 700, according to an embodiment of the present invention, includes a transmission module 710, a reception module 720, a status identification module 730, and a control module 740. The electronic device 700, according to an embodiment of the present invention, corresponds to the node described in relation to FIGS. 2 to 6.

The transmission module 710 transmits a broadcast message and a unicast message to a neighbor electronic device. According to an embodiment of the present invention, the transmission module 710 periodically transmits the broadcast message and the unicast message according to a predetermined ratio of the number of unicast message transmissions to the number of broadcast message transmissions.

According to an embodiment of the present invention, the transmission module 710 transmits a broadcast message in a predetermined period and transmits a unicast message according to an occurrence of an event causing a change in a network status. The event includes at least one of receiving a broadcast message from a new neighbor electronic device and not receiving a broadcast message within a predetermined time from a neighbor electronic device from which a broadcast message has been previously received.

The reception module 720 receives a unicast acknowledgement message for the unicast message and broadcast messages and a unicast message from neighbor electronic devices.

The status identification module 730 identifies the network status on the basis of the unicast acknowledgement message, the broadcast messages and the unicast message received from the neighbor electronic device.

The control module 740 adaptively adjusts a ratio of the number of unicast message transmissions to the number of broadcast message transmissions for each electronic device according to link qualities with the neighbor electronic devices, a moving speed of the electronic device 700, or the number of the neighbor electronic devices. In an embodiment of the present invention, the electronic device 700 transmits a unicast message including its presence information to at least one of the neighbor electronic devices of the network. The electronic device 700 receives an acknowledgement message for the unicast message and receives first broadcast messages each of which includes presence information on each neighbor electronic device.

In an embodiment of the present invention, the electronic device 700 transmits a second broadcast message including its presence information to the neighbor electronic devices.

In an embodiment of the present invention, the electronic device 700 further includes a process of identifying the network status on the basis of the unicast acknowledgement message and the first broadcast messages and a unicast message received from the neighbor electronic devices.

In an embodiment of the present invention, the electronic device 700 periodically transmits at least one of the second broadcast message and a unicast message according to a predetermined ratio of the number of unicast message transmissions to the number of second broadcast message transmissions or a specified transmission period.

In an embodiment of the present invention, the electronic device 700 determines the ratio of the number of unicast message transmissions to the number of second broadcast message transmissions or the transmission period on the basis of the network status, and transmits the second broadcast message and the unicast message.

In an embodiment of the present invention, the identification of the network status in the electronic device 700 includes determining at least one of a neighbor electronic device which is able to communicate with the electronic device 700 and link quality with the neighbor electronic device which is able to communicate with the electronic device 700.

In an embodiment of the present invention, the electronic device 700 adaptively adjusts the ratio of the number of unicast message transmissions to the number of second broadcast message transmissions or the transmission period according to the link quality, a movement speed thereof, and the number of neighbor electronic devices.

In an embodiment of the present invention, the electronic device 700 increases the ratio of the number of unicast message transmissions to the number of second broadcast message transmissions as the link quality decreases.

In an embodiment of the present invention, the electronic device 700 decreases the transmission period of the unicast message as the link quality decreases.

In an embodiment of the present invention, the electronic device 700 increases the ratio of the number of unicast message transmissions to the number of second broadcast message transmissions as the movement speed thereof increases.

In an embodiment of the present invention, the electronic device 700 decreases the transmission period of the unicast message to the broadcast message as the movement speed thereof increases.

In an embodiment of the present invention, the electronic device 700 further increases the ratio of the number of second broadcast message transmissions to the number of unicast message transmissions as the number of neighbor electronic devices increases.

In an embodiment of the present invention, the electronic device 700 decreases the transmission period of the second broadcast message to the transmission times of the unicast messages as the number of neighbor electronic devices increases.

In an embodiment of the present invention, the electronic device 700 transmits a unicast message in response to an occurrence of an event associated with the network status. The event may include at least one of receiving a first broadcast message from a new neighbor electronic device and not receiving the first broadcast message within a predetermined time from a neighbor electronic device from which a first broadcast message has previously been received.

In an embodiment of the present invention, when an event occurs when a broadcast message is not received within a predetermined time from a neighbor electronic device from which a broadcast message has previously been received, the electronic device 700 transmits a unicast message, identifies, on the basis of a unicast acknowledgement message, whether it is due to a temporary disconnection within a coverage area thereof or that the neighbor electronic device is out of the coverage area thereof, and updates the topology information of the electronic device 700 when the neighbor electronic device is identified to be out of the coverage area of the electronic device 700.

In an embodiment of the present invention, the electronic device 700 retransmits a unicast message, when the unicast acknowledgement message is not received within a predetermined time from the neighbor electronic device to which the unicast message has been transmitted.

In a topology management method according to an embodiment of the present invention, a node transmits a broadcast message including its presence information to neighbor electronic devices in an ad-hoc network, transmits a unicast message including its presence information to one of the neighbor electronic devices, receives a unicast acknowledgement message for the unicast message, and identifies a network status on the basis of the unicast acknowledgement message, and broadcasts messages and a unicast message received from the neighbor electronic devices.

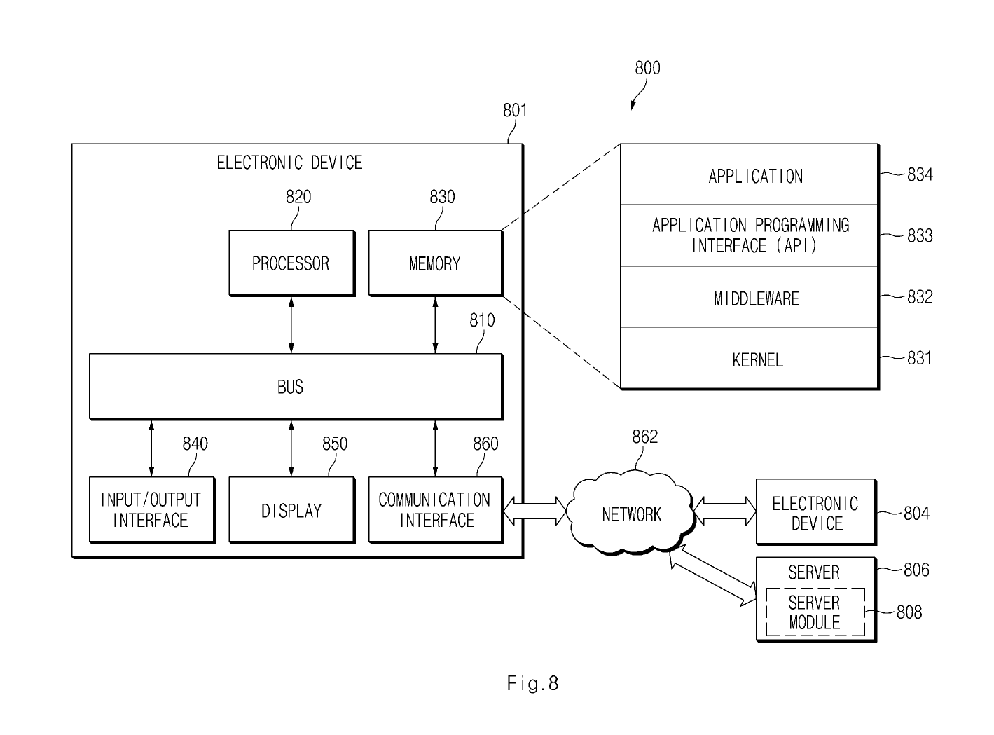

FIG. 8 is a block diagram of a system 800 including an electronic device 801 according to an embodiment of the present invention.

The electronic device 801 may represent the node. Referring to FIG. 8, the electronic device 801 includes a bus 810, a processor 820, a memory 830, an input/output interface 840, a display 850, and a communication interface 860.

The bus 810 is a circuit that connects the above-described elements to each other, and delivers communication (e.g., a control message) between the elements.

The processor 820 receives commands from other elements (e.g., the memory 830, the input/output interface 840, the display 850, or the communication interface 860, etc.), interprets the received commands, and executes operations or processes data according to the interpreted commands.

The memory 830 stores commands or data received from or created by the processor 820 or the other elements (e.g., the memory 830, the input/output interface 840, the display 850, or the communication interface 860, etc.). The memory 830 includes, for example, programming modules such as a kernel 831, middleware 832, an Application Programming Interface (API) 833 or an application 834. Each of the programming modules is configured with software, firmware, hardware, or a combination of at least two thereof.

The kernel 831 controls or manages system resources (e.g., the bus 810, the processor 820, or the memory 830, etc.) used for executing operations or functions implemented in other programming modules, for example, the middleware 832, the API 833 or the application 834. In addition, the kernel 831 provides an interface capable of accessing an individual element of the electronic device 801 from the middleware 832, the API 833 or the application 834 and controlling or managing it.

The middleware 832 plays a relay role allowing the API 833 or the application 834 to communicate and transmit or receive data with the kernel 831. In addition, the middleware 832 performs a control (e.g., scheduling or load balancing) on a job request, for example, a method of allocating priorities of using system resources (e.g., the bus 810, the processor 820, or the memory 830, etc.) of the electronic device 801 to at least one application of the application 834, in relation to the job request received from the application 834.

The API 833 is an interface allowing the application 834 to control a function provided in the kernel 831 or the middleware 832 and includes, for example, at least one interface or function (e.g., an instruction) for file control, window control, image processing or character control.

According to an embodiment of the present invention, the application 834 includes an Short Message Service/Multimedia Messaging Service (SMS/MMS) application, an email application, a calendar application, an alarm application, a health application (e.g., an application for measuring an exercise amount or blood sugar level) or an environmental information application (e.g., an application for providing atmospheric pressure, humidity, or temperature information). Additionally, or alternatively, the application 834 may be an application related to information exchange between the electronic device 801 and an external electronic device (e.g., electronic device 804). The application related to the Information exchange may include, for example, a notification relay application for relaying information to the external electronic device, or a device management application for managing the external electronic device.

For example, the notification relay application may include a function for relaying notification information created by other applications (e.g., the SMS/MMS application, email application, health application or environmental information application) of the electronic device 801 to the external electronic device (e.g., the electronic device 804). Additionally or alternatively, the notification relay application may, for example, receive notification information from the external electronic device (e.g., the electronic device 804) and provide it to the user. The device management application may manage (e.g., install, delete, or update) a function (e.g., turn on/off the external electronic device (or, a portion of a component) or a brightness (or resolution) control of the display) for at least a portion of the external electronic device (e.g., the electronic device 804), an application operating in the external electronic device, or a service provided by the external electronic device.

According to an embodiment of the present invention, the application 834 includes an application designated according to attributes (e.g., a kind of the electronic device) of the external electronic device (e.g., the electronic device 804). For example, when the external electronic device is a Moving Picture Experts Group Audio Layer 3 (MP3) player, the application 834 includes an application related to music playback. Similarly, when the external electronic device is mobile medical equipment, the application 834 includes an application related to health management. According to an embodiment of the present invention, the application 834 may include at least one of an application designated in the electronic device 801 and an application received from the external electronic device (e.g., the server 806 or the electronic device 804).

The input/output interface 840 delivers commands or data input from the user via an input/output device (e.g., a sensor, keyboard, or touch screen) to the processor 820, the memory 830, or the communication interface 860 via, for example, the bus 810. For example, the input/output interface 840 provides data for a user's touch input via a touch screen to the processor 820. In addition, the input/output interface 840 outputs, via the input/output device (e.g., a speaker or display), commands or data received from the processor 820, the memory 830, or the communication interface 860 via, for example, the bus 810. For example, the input/output interface 840 may output voice data processed via the processor 820 to the user via the speaker.

The display 850 displays various pieces of Information (e.g., multimedia data or text data, etc.) to the user.

The communication interface 860 facilitates communication between the electronic device 801 and the external device (e.g., the electronic device 804 or server 806). For example, the communication interface 860 is connected to the network 862 via wireless communication or wired communication and communicates with the external device. Wireless communication includes at least one of, for example, WIreless FIdelity (Wi-Fi), Bluetooth (BT), Near Field Communication (NFC), Global Positioning System (GPS), or cellular communication (e.g., Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro) or Global System for Mobile Communications (GSM). The wired communication may include at least one of, for example, a Universal Serial Bus (USB), a High Definition Multimedia Interface (HDMI), a Recommended Standard (RS)-232, and Plain Old Telephone Service (POTS).

According to an embodiment of the present invention, the network 862 is a telecommunications network. The telecommunications network may include at least one of a computer network, the Internet, an Internet of Things, and a telephone network. According to an embodiment of the present invention, a protocol (e.g., a transport layer protocol, a data link layer protocol, or a physical layer protocol, etc.) for communication between the first electronic device 801 and the external device may be supported by at least one of the application 834, the API 833, the middleware 832, the kernel 831, and the communication interface 860.

According to an embodiment of the present invention, the server 806 supports driving of the electronic device 801 by performing at least one operation among operations (or functions) implemented in the electronic device 801. For example, the server 806 may include a server module 808 implemented in the system 800.

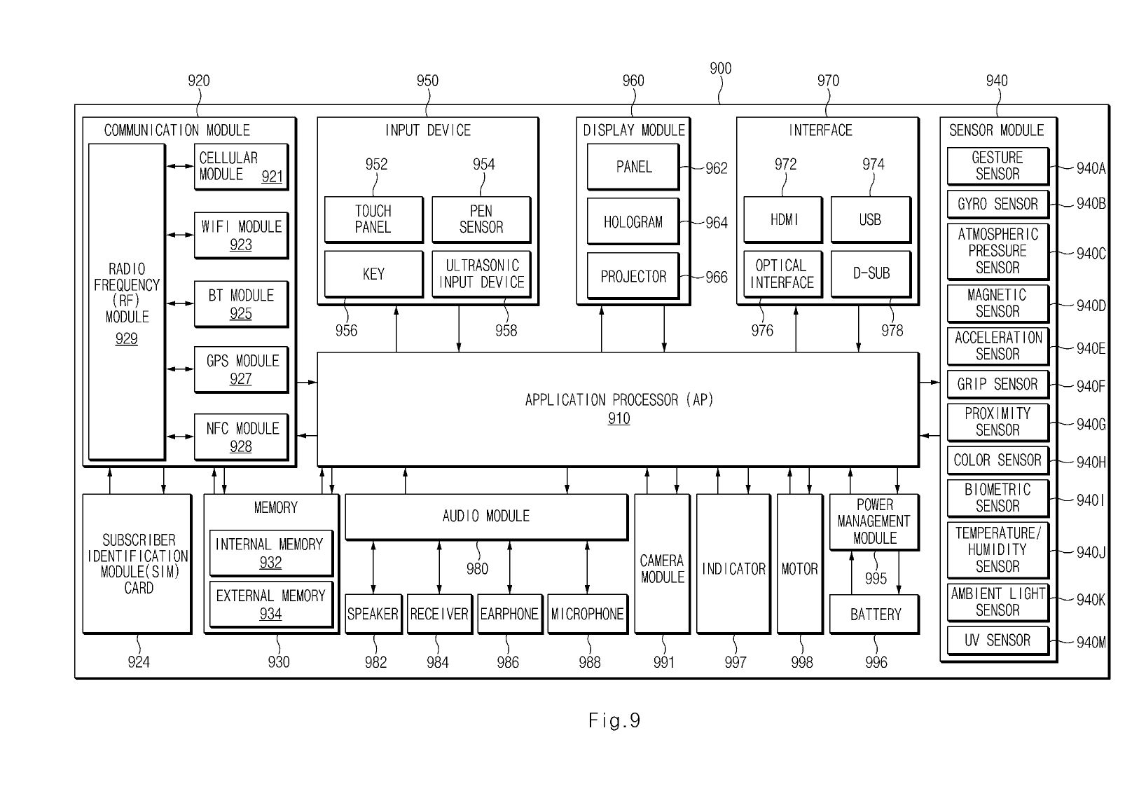

FIG. 9 is a block diagram of an electronic device 900 according to an embodiment of the present invention.

Referring to FIG. 9, the electronic device 900 includes at least one Application Processor (AP) 910, a communication module 920, a Subscriber Identification Module (SIM) card 924, a memory 930, a sensor module 940, an input device 950, a display module 960, an interface 970, an audio 3 module 980, a camera module 991, a power management module 995, a battery 996, an indicator 997, or a motor 998.

The AP 910 drives an operating system or an application program, controls a plurality of hardware or software elements connected thereto, and performs various data processing and operations including multimedia data. The AP 910 may be implemented with, for example, a System on Chip (SoC). According to an embodiment of the present invention, the AP 910 further includes a Graphics Processing Unit (GPU).

The communication module 920 performs data transmission and reception in communication between the electronic device 900 and other electronic devices connected via a network. According to an embodiment of the present invention, the communication module 920 includes a cellular module 921, a Wi-Fi module 923, a BT module 925, a GPS module 927, an NFC module 928, and a Radio Frequency (RF) module 929.

The cellular module 921 provides a voice call, a video call, a text messaging service, or an Internet service, etc., via a communication network (e.g., LTE, LTE-A, CDMA, WCDMA, UMTS, WiBro, or GSM, etc.). In addition, the cellular module 921 discriminates or authenticates an electronic device in a communication network by using, for example, a Subscriber Identification Module (e.g., the SIM card 924). According to an embodiment of the present invention, the cellular module 921 performs at least a portion of a function enabled by the AP 910. For example, the cellular module 221 may perform at least a portion of multimedia control function.

According to an embodiment of the present invention, the cellular module 921 includes a Communication Processor (CP). In addition, the cellular module 921 may be implemented with, for example, an SoC. Although, in FIG. 8, the elements such as the cellular module 921 (e.g., CP), the memory 930 and the power management module 995 are illustrated as separate from the AP 910, according to an embodiment of the present invention, the AP 910 may be implemented to include at least some (e.g., the cellular module 921) of the above-described elements.

According to an embodiment of the present invention, the AP 910 or the cellular module 921 (e.g., CP) may load, on a volatile memory, commands or data received from at least one of a nonvolatile memory and other elements and process them. Furthermore, the AP 910 or the cellular module 921 may store, in the nonvolatile memory, data received from or created by at least one other element.

The Wi-Fi module 923, the BT module 925, the GPS module 927 or the NFC module 928 may respectively include, for example, a processor for processing data transmitted or received via the corresponding module. Although, in FIG. 9, the cellular module 921, the Wi-Fi module 923, the BT module 925, the GPS module 927 or the NFC module 928 is illustrated as separate blocks, according to an embodiment of the present invention, at least some (e.g., at least two) of them may be included in a single Integrated Circuit or chip (IC) or an IC package. For example, at least some (e.g., a CP corresponding to the cellular module 921 and a Wi-Fi processor corresponding to the Wi-Fi module 923) of processors respectively corresponding to the cellular module 921, the Wi-Fi module 923, the BT module 925, the GPS module 927 and the NFC module 928 may be implemented as one SoC.

The RF module 929 transmits or receives data, for example, an RF signal. Although not shown in the drawing, the RF module 929 may include, for example, a transceiver, a Power Amp Module (PAM), a frequency filter, or a Low Noise Amplifier (LNA), etc. In addition, the RF module 929 may further include components, for example, a conductor or a wire for transmitting or receiving an electromagnetic wave in free space in a wireless communication. In FIG. 9, although the cellular module 921, the Wi-F module 923, the BT module 925, the GPS module 927 and the NFC module 928 are illustrated as sharing one RF module 929, according to an embodiment of the present invention, at least one of the cellular module 921, the Wi-Fi module 923, the BT module 925, the GPS module 927 and the NFC module 928 may transmit or receive an RF signal via a separate RF module.

The SIM card 924 is a card including a Subscriber Identification Module and may be inserted into a slot formed at a position of the electronic device 900. According to an embodiment of the present invention, the SIM card 924 is embedded in the electronic device in a chip type or stored in a portion (e.g., an electronic SIM, virtual SIM, or soft SIM) of the corresponding electronic device 900 without any physical form. The SIM card 924 includes identification information (e.g., Integrated Circuit Card IDentifier (ICCID)) or subscriber information (e.g., International Mobile Subscriber Identity (IMSI)).

The memory 930 includes an internal memory 932 or an external memory 934. The Internal memory 932 includes at least one of, for example, a volatile memory (e.g., a Dynamic Random Access Memory (DRAM), Static RAM (SRAM), Synchronous Dynamic RAM (SDRAM) etc.) and a nonvolatile memory (e.g., a One-Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, NOR flash memory etc.).

According to an embodiment of the present invention, the Internal memory 932 may be a Solid State Drive (SSD). The external memory 934 may further include a flash drive, for example, Compact Flash (CF) memory card, Secure Digital (SD) memory card, micro-Secure Digital (micro-SD) memory card, mini Secure Digital (mini-SD) memory card, extreme digital (xD) memory card, or a memory stick. The external memory 934 may be functionally connected to the electronic device 900 via various interfaces. According to an embodiment of the present invention, the electronic device 900 further includes a storage device (or storage medium) like a hard drive.

The sensor module 940 measures a physical quantity or detects an operating state of the electronic device 900, and converts the measured or detected information into an electrical signal. The sensor module 940 include at least one of, for example, a gesture sensor 940A, a gyro sensor 940B, an atmospheric pressure sensor 940C, a magnetic sensor 940D, an acceleration sensor 940E, a grip sensor 940F, a proximity sensor 940G, a color sensor 940H (e.g., Red, Green, Blue (RGB) sensor), a biometric sensor 940I, a temperature/humidity sensor 940, an ambient light sensor 940K, and an Ultra Violet (UV) sensor 940M. Additionally or alternatively, the sensor module 940 may include, for example, an e-nose sensor, an ElectroMyoGraphy (EMG) sensor, an ElectroEncephaloGram (EEG) sensor, an ElectroCardioGram (ECG) sensor, an Infra-Red (IR) sensor, an iris sensor, or a fingerprint sensor, etc. The sensor module 940 may further include a control circuit for controlling at least one sensor therein.

The input device 950 includes a touch panel 952, a (digital) pen sensor 954, a key 956, or an ultrasonic input device 958. The touch panel 952 recognizes a touch input in at least one of capacitive, pressure-sensitive, infra-red ray, and surface acoustic wave type. In addition, the touch panel 952 may further include a control circuit. In the case of a capacitive type, physical contact or proximity recognition is possible. The touch panel 952 may further include a tactile layer. In this case, the touch panel 952 provides a tactile reaction to the user.

The (digital) pen sensor 954 may be implemented by using, for example, a method identical or similar to receiving a user's touch input or a separate recognition sheet. The key 956 may include, for example, physical buttons, or optical keys or a keypad. The ultrasonic input device 958 is a device able to detect a sound wave via a microphone (e.g., a mic 988) and confirm data in the electronic device 900 via an input tool generating an ultrasonic wave signal, and may be a device where wireless awareness is possible. According to an embodiment of the present invention, the electronic device 900 receives a user input from an external device (e.g., a computer or a server) via the communication module 920.

The display module 960 includes a panel 962, a hologram device 964 or a projector 966. The panel 962 may be, for example, a Liquid Crystal Display (LCD) or an Active-Matrix Organic Light-Emitting Diode (AMOLED). The panel 962 may be implemented as, for example, flexible, transparent or wearable. The panel 962 may be configured as one module with the touch panel 952. The hologram device 964 displays a stereoscopic image in the air by using interference of light. The projector 966 displays an image by projecting light onto a screen. The screen may be located, for example, inside or outside of the electronic device 900.

The interface 970 includes, for example, a High-Definition Multimedia Interface (HDMI), 972, a Universal Serial Bus (USB) 974, an optical interface 976 or a D-subminiature (D-sub) connector 978. Additionally or alternatively, the interface 970 may include, for example, a Mobile High-definition Link (MHL) interface, a Secure Digital (SD) card/MultiMedia Card (MMC) Interface, or an Infrared Data Association (IrDA) specification interface.

The audio module 980 converts sound into an electrical signal, or vice versa. The audio module 980 processes sound information input from or output to, for example, a speaker 982, a receiver 984, an earphone 986 or a microphone 988.

The camera module 991 is a device for capturing a still image or a video, and, according to an embodiment of the present invention, may include at least one image sensor (e.g., a front sensor or a rear sensor), a lens, an Image Signal Processor (ISP), or a flash (e.g., a Light Emitting Diode (LED) or xenon lamp).

The power management module 995 manages power of the electronic device 900. Although not shown in the drawing, the power management module 995 may include, for example, a Power Management Integrated Circuit (PMIC), a charger integrated circuit, a battery, or a fuel gauge.

The PMIC may be embedded, for example, in an IC or inside an SoC. A charging scheme may be divided into a wireless and wired scheme. The charging IC may charge the battery and block inflow of over-voltage or over-current from a charger. According to an embodiment of the present invention, the charging IC may include a charging IC for at least one of wired charging scheme or wireless charging scheme. As the wireless charging scheme, for example, there is a magnetic resonance scheme, inductive coupling scheme, or microwave scheme. An additional circuit, for example, a coil loop, resonance circuit, or rectifier etc, may be further included for wireless charging.

The battery gauge measures, for example, remnants of the battery 996, voltage, current or temperature while being charged. The battery 996 stores or generates electricity and supplies power to the electronic device 900 using the stored or generated electricity. The battery 996 may include, for example, a rechargeable battery or a solar battery.

The indicator 997 displays a state of the electronic device 900 or a portion thereof (e.g., the AP 910), for example, a booting state, a message state or a charging state, etc. The motor 998 converts an electrical signal into a mechanical vibration. Although not shown in the drawing, the electronic device 900 may include a processing device (e.g., a GPU) for supporting a mobile TV. The processing device for supporting the mobile TV may process media data complying with specifications such as Digital Multimedia Broadcasting (DMB), Digital Video Broadcasting (DVB), or media flow, etc.

Each of the above-described elements according to an embodiment of the present invention may be configured with one or more components, and a name of a corresponding element may vary according to a kind of electronic device. An electronic device according to an embodiment of the present invention may be configured with at least one element among the above-described elements and some elements may be omitted or additional other elements may be further included. Furthermore, some elements of an electronic device according to an embodiment of the present invention may be combined into one entity and perform the same functions as those of the corresponding elements before the combination.

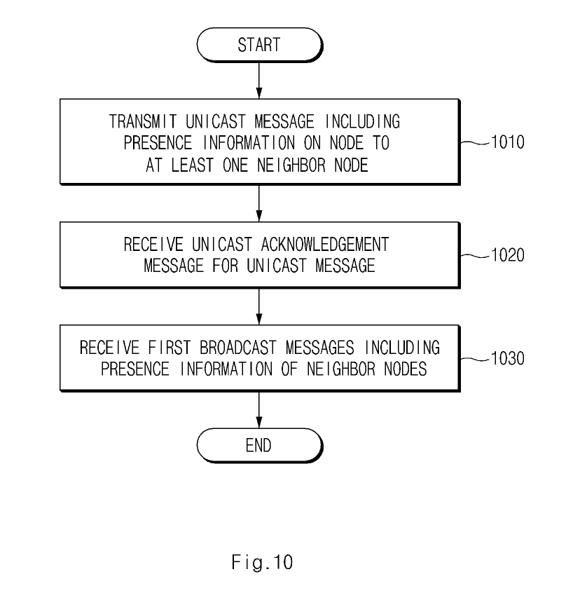

FIG. 10 is a flowchart of a topology management method performed in each node of an ad-hoc network system according to an embodiment of the present invention.

Referring to FIG. 10, the flowchart Illustrated in FIG. 10 includes steps processed in at least one node illustrated in FIG. 2 or 7. Although omitted hereinafter, content described above in relation to at least one node in FIG. 2 or 7 may also be applied to the flowchart in FIG. 10.

In step 1010, a node transmits a unicast message including its presence information to at least one neighbor nodes in a network.

In step 1020, the node receives a unicast acknowledgement message for the unicast message.

In step 1030, the node receives first broadcast messages each of which includes presence information of each of the neighbor nodes.

According to an embodiment of the present invention, the node may transmit a second broadcast message including its presence information to the neighbor nodes in the network.

The electronic device 900 of the network according to an embodiment of the present invention may further include a transmission module transmitting the second broadcast message or the unicast message including its presence information to neighbor electronic devices, a reception module receiving a unicast acknowledgement message for the unicast message and the first broadcast messages and a unicast message from the neighbor electronic devices, a status identification module identifying a network status on the basis of the unicast acknowledgement message for the unicast message, the first broadcast messages and the unicast message received from the neighbor electronic devices.

According to an embodiment of the present invention, the transmission module periodically transmits a second broadcast message and a unicast message according to a predetermined ratio of the number of unicast message transmissions to the number of second broadcast message transmissions and a predetermined transmission period.

According to an embodiment of the present invention, the control module adaptively adjust the ratio of the number of unicast message 1o transmissions over the number of second broadcast message transmissions for each electronic device according to link qualities with the neighbor electronic devices, a moving speed of the electronic device, or the number of neighbor electronic devices.

According to an embodiment of the present invention, the transmission module transmits the second broadcast message in the predetermined period and transmits the unicast message in response to an occurrence of an event causing a change in a network status. The event may include at least one of receiving a first broadcast message from a new neighbor electronic device and not receiving the first broadcast message within a predetermined time from a neighbor electronic device from which a first broadcast message has been previously received.

In addition, the method can be written as computer programs and can be implemented in a general-purpose digital computer that executes the programs using a non-transitory computer readable recording medium. Examples of the non-transitory computer readable recording medium include magnetic storage media (e.g., ROM, floppy disks, hard disks, etc.) and optical recording media (e.g., Compact Disc ROMs (CD-ROMs), or Digital Video Discs (DVDs)).

According to an embodiment of the present invention, an electronic device in a network can rapidly and accurately identify a network status by using broadcast and unicast messages.

A node can measure link quality and manage topology on the basis of connections between nodes. In addition, a node can rapidly identify whether a neighbor node is out of a coverage area of the node or is in a temporary disconnection status in the coverage area.

Accordingly, each electronic device in the network can reduce data loss and secure a stable packet transmission route.

While embodiments of the present invention have been shown and described above, it will be understood by one of ordinary skill in the art that various changes in form and details may be made therein without departing from the scope and spirit of the present inventive concept as defined by the appended claims and their equivalents. The above-described embodiments should be considered in a descriptive sense only and not for purposes of limitation. Therefore, the scope of the invention is defined not by the detailed description of embodiments of the present invention but by the appended and their equivalents.

What is claimed is:

1. A topology management method of a node, the method comprising:
transmitting, by the node, a unicast message comprising its presence information to at least one neighbor node in a network;
receiving, by the node, an acknowledgement message for the unicast message; and
receiving, by the node, first broadcast messages each of which comprises presence information on each of the at least one neighbor node.

2. The method according to claim 1, further comprising transmitting a second broadcast message comprising its presence information to the at least one neighbor node.

3. The method according to claim 1, further comprising identifying a network status on a basis of the unicast acknowledgement message and the first broadcast messages and a unicast message from the at least one neighbor node.

4. The method according to claim 2, further comprising periodically transmitting at least one of the second broadcast message and the unicast message according to a predetermined ratio of a number of unicast message transmissions to a number of second broadcast message transmissions or a predetermined transmission period.

5. The method according to claim 2, further comprising:
determining the ratio of the number of unicast message transmissions to the number of second broadcast message transmissions or the transmission period; and
transmitting the second broadcast message or the unicast message according to the determined ratio or transmission period.

6. The method according to claim 5, further comprising adaptively adjusting the ratio of the number of unicast message transmissions to the number of second broadcast message transmissions or the transmission period for each of the at least one neighbor node according to at least one of link quality, a movement speed of the node, and a number of the at least one neighbor node.

7. The method according to claim 6, wherein adaptively adjusting the ratio is performed by increasing the ratio of the number of unicast message transmissions to the number of second broadcast message transmissions as the link quality decreases.

8. The method according to claim 6, wherein adaptively adjusting the ratio is performed by increasing the ratio of the number of unicast message transmissions to the number of second broadcast message transmissions as the movement speed increases.

9. The method according to claim 6, wherein adaptively adjusting the ratio is performed by increasing the ratio of the number of unicast message transmissions to the number of second broadcast message transmissions as the number of the at least one neighbor node increases.

10. The method according to claim 1, wherein transmitting the unicast message is performed by transmitting the unicast message in response to an occurrence of an event associated with a status of the network.

11. The method according to claim 10, where the event comprises at least one of receiving a first broadcast message from a new at least one neighbor node and not receiving the first broadcast message within a predetermined time from one of the at least one neighbor node from which a first broadcast message has been previously received.

12. The method according to claim 1, wherein transmitting the unicast message comprises transmitting the unicast message when an event occurs where the first broadcast message is not received within a predetermined time from one of the at least one neighbor node from which a first broadcast message has been previously received, and
wherein identifying a status of the network, comprises:
identifying whether a temporary disconnection occurs in a coverage area of the node or the at least one neighbor node is out of the coverage area of the node on the basis of the unicast acknowledgement message; and
when the at least one neighbor node is identified to be out of the coverage area of the node, updating topology information of the node.

13. The method according to claim 1, further comprising retransmitting the unicast message when the unicast acknowledgement message is not received within a predetermined time from the at least one neighbor node to which the unicast message has been transmitted.

14. A non-transitory computer readable recording medium having a program recorded thereon, which, when executed by a computer, performs a topology management method, the method comprising:
transmitting, by a node, a unicast message comprising its presence information to at least one neighbor node in a network;
receiving, by the node, an acknowledgement message for the unicast message; and
receiving, by the node, first broadcast messages each of which comprises presence information on each of the at least one neighbor node.

15. An electronic device of a network, comprising:
a transmission module configured to transmit a second broadcast message or a unicast message comprising its presence information to neighbor electronic devices;
a reception module configured to receive a unicast acknowledgment message for the unicast message and first broadcast messages and a unicast message from the neighbor electronic devices; and
a status identifying module configured to identify a status of the network on a basis of the unicast acknowledgment message and the first broadcast messages and the unicast message received from the neighbor electronic devices.

16. The electronic device according to claim 15, wherein the transmission module is further configured to periodically transmit the second broadcast message or the unicast message according to a predetermined ratio of a number of unicast message transmissions to a number of second broadcast message transmissions or a predetermined transmission period.

17. The electronic device according to claim 15, further comprising a control module configured to adaptively adjust the ratio of the number of unicast message transmissions to the number of second broadcast message transmissions or the transmission period for each of the neighbor electronic devices according to at least one of link qualities with the neighbor electronic devices, a movement speed of the electronic device, and a number of the neighbor electronic devices.

18. The electronic device according to claim 15, wherein the transmission module is further configured to transmit the second broadcast message in a predetermined period and transmit the unicast message in response to an occurrence of an event associated with the status of the network.

19. The electronic device according to claim 18, wherein the event comprises at least one of receiving a first broadcast message from a new neighbor electronic device and not receiving the first broadcast message within a predetermined time from one of the neighbor electronic devices from which a first broadcast message has been previously received before.
